(19) United States
(12) Patent Application Publication
(10) Pub. No.: US 2015/0202957 A1
(43) Pub. Date: Jul. 23, 2015

(54) Anti-Siphon Device

(71) Applicant: Robert Richard Kneisley, Toledo, OH (US)

(72) Inventor: Robert Richard Kneisley, Toledo, OH (US)

(21) Appl. No.: 14/678,931

(22) Filed: Apr. 4, 2015

Related U.S. Application Data
(63) Continuation-in-part of application No. 13/752,363, filed on Jan. 28, 2013.

(51) Int. Cl. B60K 15/04

(52) U.S. Cl. CPC B60K 15/0403

(57) ABSTRACT

The invention comprises a device that can be inserted into an inlet for a gasoline or diesel fuel tank, and which, after being inserted, prevents thieves from using siphons to steal gasoline from the tank. Embodiments of the device can protect the fuel supplies of automobiles, trucks, boats, and other motor vehicles. The invention uses “locking legs”, a unique feature, which lock against the flanges of the inlet and ensure that the device cannot be easily removed from the inlet after insertion. Embodiments of the device also use a “hose spear” which punctures thieves' siphons, and makes them unable to remove gasoline or other liquids from the tank. The device can be used to stop theft of other liquids. The invention also includes a process of protecting liquids from theft using a device with “locking legs”, and a process for inserting the device into an inlet.

### RELATED APPLICATIONS

This application claims priority from U.S. patent application Ser. No. 13/752,363, filed Jan. 28, 2013, with Robert Richard Kneisley as the inventor. That application, in turn, claims priority to U.S. Provisional Patent Application 1-196194885, filed Feb. 12, 2012, with Robert Richard Kneisley as the inventor. These applications are both incorporated by reference in their entirety.

### BACKGROUND OF THE INVENTION

Fuel theft costs at least $9 billion of dollars, every year, to U.S. consumers and industry, according to some estimates. Fuel theft also indirectly increases gas prices at the pump, and high fuel prices are detrimental to America's fragile economic recovery.

Most boats, trucks, and automobiles are designed to be refueled via inlets which lead from the outside to their gasoline tanks.

Thieves sometimes steal gasoline or diesel fuel from a boat or motor vehicle by inserting a hose, called a “siphon” into the inlet of the gasoline tank of the boat or automobile. The siphon then sucks gasoline from the tank through the inlet. The part of the hose that actually sucks the gasoline may also be called a “tentacle”. This is the most common method of fuel theft in the United States.

Some newer vehicles and vessels have some form of anti-theft protection, but tens of millions of older vehicles presently have no anti-siphon protection. The invention relates to an easily installed anti-siphon device to prevent the siphoning of gasoline from the fuel tank of a motor vehicle or vessel. The “drop-in” method of installation requires no tools to install and works equally well with gasoline or diesel fuel. The device that we seek to patent includes integral “locking legs” in its design. The design of the device also uses a reduced amount of material. These features lower the cost of the device to consumers and assure effective use of the device.

For purposes of this application, the term “vehicle” should be taken to include, but not be limited to, boats, automobiles, and trucks.

Our device also has the additional advantage that it is easy to install a vehicle, and can be installed without any disassembly of the device or the vehicle. Our device also fulfills a long-felt but unsolved need for stopping theft of gasoline and diesel fuel from boats and other vehicles.

### FIELD OF THE INVENTION

This invention relates generally to the field of devices for preventing siphoning of gasoline from gasoline tanks on motor vehicles and boats.

Several anti-siphon devices have been patented, but they are fundamentally different from our claimed invention. It will be useful to discuss the pertinent prior art, and to discuss the differences between the present invention and the prior art.

The anti-siphon design in U.S. Pat. No. 7,721,902 involves a tubular device designed to fit against the inner wall of the gasoline inlet, which is fundamentally different from the present invention, which includes an assembly of legs and a blocking component which stops thieves from using siphons to steal fuel. The present invention can be squeezed to make it thinner, inserted into the inlet (6) in this thinner form, and then the pressure that the user is exerting on the device is released, so that the device will spring back into its regular form.

U.S. Pat. No. 4,343,410 by Lenda discloses a coiled, hourglass-shaped spring mounted within a three-prong tubular cage. This device works by being permanently installed in a gas tank, which is different from the present invention. The present invention involves no springs, does not include a cage, and is designed to be easily inserted into the gas tank. Once the device locks against the flanges (8), removing the device from the gas tank becomes very difficult. This simplicity increases the utility of the present invention.

U.S. Pat. No. 3,991,792 discloses a recoiled spring device designed to prevent the siphoning of gasoline, but this, again, differs from the present invention, which involves no springs, and is therefore simpler to construct.

U.S. Pat. No. 2,496,992 by Glidden discloses a device intended to prevent siphoning of gasoline, but Glidden's device includes a tubular structure, and does not appear to include legs that lock, onto the flanges of the inlet. The locking legs of the present invention make the tubular structure unnecessary.

U.S. Pat. No. 2,281,448 by Mathey discloses a structure for partially obstructing a pipe, but this device also does not include the locking legs of the present invention. The locking legs give the device of the present invention the ability to be inserted into an inlet, to lock to the inlet automatically, and to be locked to prevent removal. This is a substantial improvement on the device of Mathey.

Pat. D637698 by Greene discloses the ornamental design of an anti-siphon device, but this anti-siphon device seems to be an additional type of gasoline tank cap that blocks siphons and has small holes for gasoline to pass through. This is different from the present invention, that is much thinner and blocks far less of a gasoline inlet, in which it is inserted, then Greene's invention.

U.S. Pat. No. 4,438,862 by Bona discloses an anti-siphon device, but this device is very different from the present invention. Bona's device relies on having a central rod, which is anchored within the filler pipe. Our device, by contrast, does not have a central rod. It relies on four locking legs, which lock against the flanges of the gasoline inlet, and which are caused to stay in position, locked against the flanges, by the configuration of the internal components of our device, which create pressure against the locking legs to stay locked against the flanges. The components of our device are also much lighter, thinner, and therefore easier to manufacture than the “body” of Bona's device.

Pat. D588,055 by Moya discloses another ornamental design for an anti-siphon device. This device functions on different principles from the present design, and seems to only be capable of blocking a gasoline inlet, unlike the present invention, which blocks a gasoline inlet and has a hose spear to puncture any siphons that are inserted into the inlet.

U.S. Pat. No. 8,281,947 by Walkowski discloses an anti-siphon device, but this anti-siphon device is a ring that is designed to stop siphons. The theory behind this device is different from the theories behind our device, which is based on a group of thin components which create interlocking forces, and which involves a hose spear to puncture siphons.

U.S. Pat. No. 8,376,169 by Keefer involves an anti-siphon installation assembly, which seems to be designed for the purpose of allowing installation of an anti-siphon device. Our device, by contrast, is an anti-siphon device. Furthermore, Keefer's device involves nothing similar to the locking legs of our device, but seems to focus on a cap and other elements that support the cap.

U.S. Pat. No. 8,459,483 by Bisaillon discloses an anti-siphon device that includes a plate, a tube, vents, and a cage at the bottom which prevents insertion of siphons. It is inserted into an inlet and creates a physical barrier to siphons. Our device, however, relies on different principles from Bisaillon's device, because our device includes a hose spear, which is not included in Bisaillon's device. Furthermore, our device includes components that are shaped very differently from Bisaillon's device, and also our device is probably more lightweight than Bisaillon's device, and therefore easier and cheaper to manufacture.

U.S. Pat. No. 3,985,259 by Zell discloses a device for stopping gasoline siphons. This device relies solely on a helical spring construction to stop siphons. It does not have anything similar in effect or operation to the locking legs of our device, which are designed partly to stop our device from being removed easily from a gasoline tank inlet. Zell's device also does not have anything similar to the hose spear of our invention.

U.S. Pat. No. 2,281,448 by Alcide discusses an anti-siphon device that includes three or more wires, in a conical formation, that are attached to a central node, and block an inlet of a gasoline tank. They are attached to the outside of the tank with hooks. This is very different from the present invention, which relies on the locking legs to create pressure against the walls of the inside of the gasoline inlet, which prevents the device from being removed easily from the gasoline inlet. Furthermore, our device includes a hose spear, and Alcide's device includes nothing similar in structure or function to a hose spear.

U.S. Pat. No. 6,267,776 by O'Connell involves a filter for blood vessels, which includes filter legs. These filter legs have a very different purpose from the locking legs, or any other component, of the present invention. The locking legs of the present invention are designed to keep the device secured within a gasoline inlet and resist removal from the inlet. Furthermore, in our device, the locking legs are generally held in place by either resistance to movement created by the locking arm or by resistance to movement which is deliberately created through the connections between the other components of our device, and no component of O'Conell's device is designed to create a similar amount of resistance to movement of the filter legs of O'Connell's device. Furthermore, our device is made out of metal in our recommended embodiments, while O'Connell's device probably could not be made out of metal because it is designed to be used within the human body, and O'Connell's device might damage the individuals in whom it is placed, if O'Connell's was made out of metal. Because of the differences between the environment where O'Connell's device is to be used and the environment where our device is to be used, the components of O'Connell's device simply would not be useful with relation to the problems to be solved by our device.

A review of the prior art indicates that there is a need for a new device that stops gasoline theft by stopping siphons from being inserted into gasoline inlets, and which also is durable, reliable, cheap to manufacture, can be installed easily in a vehicle, and which punctures siphons that are inserted into the unit where it is installed, thus discouraging future attempts at gasoline theft. The new device also should not excessively block the gasoline inlet, because that would limit the ability of the vehicle owner to put gasoline into the inlet, and would also create a barrier against vapors escaping from the gasoline tank, which is sometimes desirable for relief of pressure caused by the vapors. Therefore, the components of the new device should be thin.

The new device should stop gasoline theft by stopping siphons from being inserted into the inlet leading to a vehicle's fuel tank because most fuel theft happens when a thief inserts a siphon into the inlet leading to a vehicle's fuel tank. Therefore, stopping these siphons is probably the easiest and most effective way of stopping fuel theft from happening.

### SUMMARY OF THE INVENTION

It is an objective of the invention to provide a unique, new, simple, permanently installed and improved anti-siphon device that permits rapid re-fueling of vehicles, without backward fuel flow from the fuel tank, and prevents fuel theft. A second objective of the invention is for the aforementioned anti-siphon device to be temper-proof. A third objective of the invention is for the device to be relatively cheap to manufacture, so that it can be sold cheaply to consumers. A fourth objective is for the invention to include a means puncturing or otherwise disabling siphons that are inserted into a gasoline inlet where the invention is installed, so as to deter future gasoline theft.

### Term Numbers

The following numbers shall be used to refer to different components connected to the device and the environment in which it is used. These terms shall be used to refer to parts of the application in the remainder of the summary

Locking leg components: Locking legs (1). Upper leg portion (18). Lower leg portion (7). Central leg portion (9). Upper tips (11). Lower tips (12).

Blocking element components related to first embodiment: Top portion (25). Covering loops (26). Locking arm (13).

Blocking element components related to second embodiment: Upper blocking element portion (4). Upper loops (14). Central blocking element portion (5).

Other items: Helix guards (15). Hose spear (19). Inlet (6). Flange (8).

For purposes of this application, an “inlet” shall mean an inlet into a gasoline tank on a boat or motor vehicle or other vehicle.

### DETAILED DESCRIPTION OF THE INVENTION

The device is intended to prevent theft of fuels, or any liquid, dispensed into an inlet tube, with a particular focus on inlets ½ an inch (1.27 cm) or greater in diameter. The anti-siphon design applies to ground vessels as well as marine vessel application as a “drop-in” device with unique “locking legs”, (FIG. 1 and FIG. 2) designed to contact interior pipe flanges (8) (FIG. 1). The device can be manufactured in a range of sizes. This way, similarly designed versions of the device will work with fuel inlets of a variety of sizes. Our research located a patented device covered by Pat. No. D587,463 invented by G. L. Slagel, however the design lacks our unique four or more “locking legs”, (1) that prevent removal of our device from the fuel inlet tube (6) and lock against interior flanges (8) within the inlet tube (6) prohibiting descent of our device into the fuel tank. In addition, our device requires only a small screwdriver to install in automobiles and most small trucks, and no tools to install in boats. Our device is preferably comprised in manufacture of 0.060 inch (0.1524 cm) diameter bright stainless steel spring wire to comprise the locking legs, (1), and the blocking element. There are two embodiments of our device, which we believe to be the most effective. Both embodiments will be described below. Other embodiments are possible. The first embodiment is the preferred embodiment. The second embodiment is also effective, but less effective and slightly more expensive to manufacture, because it involves welding.

It is important to note that once the device is installed in an inlet (6), it does not prevent refueling of the vehicle, because hoses for refueling will generally not reach deep enough into the inlet (6) to encounter the device, especially if the person refueling the vehicle is aware that the device has been installed. Siphons, which are intended to take fuel out of the inlet, however, will generally reach deep enough to encounter the device. They have to do this, in order to suck fuel effectively. Therefore, the device will be effective at stopping siphons.

The device is unique in that it is designed to permit hand compression of the “locking legs” (1) to permit insertion into an inlet tube (6). The preferred embodiment, and the second embodiment, can be inserted into any inlet tube (6) of ½ inch (1.27 cm) or greater in diameter without the need to disassemble the inlet tube, (6). A small screwdriver can be used to install the device in automobiles, or small trucks with inlet tubes (6) of similar dimensions. The lower portions (7) of the locking legs (1) would be compressed by hand, and inserted into the inlet (6), and the blocking element would be screwed in with a screwdriver. The lower leg portions (7) of the locking legs (1) terminate in lower tips (12). The lower leg portions (7) of the locking legs (1) move and the distance between the lower tips (12) decreases when the user squeezes the lower leg portions (7). The user then inserts the device into an inlet (6) and releases the pressure. The distance between the lower tips (12) then increases, and the locking legs (1) lock against the flanges (8) of the inlet (6). The lower tips (12) and upper tips (11) can both lock against the flanges (8). This makes the device very hard to remove from the inlet (8).

Boats generally have a larger inlet tube (6) than automobiles do, which means that a user can install the device in a boat's inlet tube (6) without any tools. Spring-tempered stainless steel is a very effective material with which to construct the invention, because of the ability of spring-tempered stainless steel to spring back into place once the pressure on it is released. Spring-tempered stainless steel is not the only possible material that the invention may be constructed out of, though.

The device, in its simplest form, comprises a blocking element, one or more locking legs (1), and a means for impeding movement of the locking legs. Some embodiments of the device may also include a “collar” area. In the collar area the means for impeding movement of the locking legs touches the central leg portion (9) of the locking legs (1) and holds them in a manner which limits their movement.

More Information about the Preferred Embodiment

The preferred embodiment utilizes bright 0.060 inch (0.1524 cm) stainless steel spring wire for the device, and has a blocking element which includes an upper blocking element portion (25), which is comprised of covering loops (26), and also a locking arm (13). The covering loops (26) and locking legs (1) are large enough so that the locking legs (1) will lock into the flanges (8) of an inlet (6) which has an entry opening of ½ inches (1.27 cm) or greater in diameter. The locking legs are each divided into an upper leg portion (18), a central leg portion (9), and a lower leg portion (7). The upper leg portion (18) begins in the upper tip (11), and the lower leg portion (7) ends in the lower tip (12). The upper leg portions (18) of the locking legs gradually converge towards the central leg portions (9) as seen in the attached figures. The central leg portions (9) are twisted together, each in a helical form, and each central leg portion (9) touches another central leg portion (9), as seen in the attached figures. The central leg portions (9) are aggregated, as seen in the attached figures. The lower leg portions (7) diverge away from the central leg portions (9), and finally terminate in the lower tips (12).

The means for impeding movement of the locking legs in the preferred embodiment comprises the locking arm (13). The locking arm (13) is recommended to be 0.47625 cm ( 3/16 inches) long. The locking arm (13) sticks between the lower leg portions (7) and physically stops at least two of the lower leg portions (7) from moving in a way that decreases the distance between the lower tips (12). When these lower leg portions (7) move in this manner, they bump into the locking arm (13), which stops them from moving closer to the other lower leg portions (7). This locking arm (13) is designed to catch the locking legs (1) and hold them in place, so that the locking legs (1) cannot easily move upward out of the flanges (8) by themselves once the device is inserted into an inlet (6). The locking arm (13) therefore helps the locking legs (1) to stay in place in the flanges (8), and adds to the ability of the device to resist attempts to remove it from the inlet (6). The pressure that the locking arm (13) places on the lower leg portions, (7) and vice versa, also makes the covering loops (26) more resistant to movement either upward or to the side, because the lower leg portions (7) press against the locking arm (13), which is attached to the top portion (25) which includes the covering loops (26). This, in turn, helps the invention in its intended purpose of stopping fuel theft. A thief attempting to put a siphon into an inlet (6) which has the device inserted into it will find that the device prevents the siphon from drawing any fuel out of the inlet (6). The locking legs (1) exert pressure on the flanges (8), which makes the locking legs, and by extension the rest of the device, difficult to remove, in part because of the additional rigidity of the device created by the locking arm (13). The structure of the top portion (25), with several covering loops (26), some of which are twisted around, and touching, the central leg portions (9) also lends additional strength and rigidity to the locking arm (13). This property also helps the device to function, because it means that a thief must exert more pressure on the device to remove it from the inlet (6).

The top portion (25) of the blocking element forms a helix, and the covering loops (26) are each loops in the helix. The top portion (25) of the blocking element of the preferred embodiment should contain at least four covering loops (26), however, it can function with fewer covering loops (26).

This embodiment also includes a hose spear (19) designed to puncture siphons that are inserted into a fuel inlet (8) where the device has been installed. The hose spear juts upwards from the aggregated central leg portions (9). The hose spear may have a sharp point, which will make it more effective at puncturing siphons. The hose spear (19) foils thieves by piercing the sealed hose end where hose siphons and smaller hose tentacles might be used; thus equalizing the suction pressure to mitigate fuel flow. The hose spear (19) thus punctures the silicone lining of a sealed hose end from a siphon, reducing suction pressure so that a siphoning hose, inserted into the inlet(6) by a thief, cannot pump fuel out of the fuel tank efficiently.

The preferred embodiment of the invention can be inserted into a fuel inlet (6) via four 360 degree turns. The covering loops (26) which are part of the blocking element form a helix, which should contain at least four covering loops (26). When screwed into a fuel inlet (6) in this manner, the locking legs (1) of the preferred embodiment will generally withstand at least 100 foot-pounds of pressure against the flanges (8), making the device an effective siphon deterrent that is very difficult to remove from the inlet (8). In this embodiment of the invention, the smaller end of the covering loops' (26) bend should have a 90 degree camber relative to the upper leg portions (18), which eliminates the need for any of the other parts of the device to be welded to the central leg portion (9). Another variation of this embodiment is possible, where the diameter of each successive covering loop (26) gradually decreases with a 45 degree camber in the part of said top portion (25) that is above said central leg portion (9) as said top portion (25) approaches said central leg portion (9).

A version of this primary embodiment that can fit into fuel inlets (6) for automobiles has the following characteristics: It includes a blocking element with a top portion (25) that is a helix with at least 4 covering loops (26), and is 6.985 cm long from the top to the bottom, where the locking arm (13) is located. This helix can be compressed to allow the locking legs (1) to be inserted into the flanges (8) of a fuel tank. Devices embodying the design of either the preferred embodiment or the second embodiment can also be designed to fit into an inlet (6) that is 1.5875 cm (⅝ inches) in diameter.

The invention is designed to protect against fuel theft from boats, light trucks, and automobiles. The preferred embodiment is manufactured from 0.060 stainless steel (0.1524 cm stainless steel), and permits hand compression and simple “drop-in” insertion into the electrically grounded inlet tube (6). There is no risk of sparks or other accidental issues related to static electricity, because inlets (6) are designed to be electrically insulated and grounded. This holds true of the other embodiments discussed here, as well.

The user may also choose to use “helix guards” (15) on the lower tips (12) and/or the upper tips (11). These may be used to reduce the possibility of damage to the inlet (6) or the locking legs (1) caused by scratching. Such helix guards (15) may be composed of metal, rubber, or other substances. It is important to note that in most cases, helix guards (15) will be unnecessary. “Helix guards” (15) designed to increase the resistance to pressure of the device, once installed, are also possible.

The principles behind this device include the idea that the locking legs will spring outward, so that the angle between the locking legs increases, when the device is placed inside a gasoline inlet, and the locking legs will be prevented from easily returning to a position that is more parallel to each other when the device is inside the inlet. Other components of the device, most specifically the means for impeding movement of the locking legs, will prevent the locking legs from doing this. In the preferred embodiment, the means for impeding movement of the locking legs is the locking arm (13).

Another principle behind this device is that the configuration of the top portion (25), with several covering loops (26) circling the locking legs, which are collectively much longer than the locking arm (13), will lend rigidity to the locking arm (13), and therefore the locking arm (13), and by extension, the device, will be more resistant to pressure brought by thieves attempting to remove the device from an inlet where the device has been placed.

In the preferred embodiment, the central leg portions (9) of the locking legs (1) are twisted together and aggregated, in a manner demonstrated by the accompanying drawings. Each of the central leg portions (9) is helical and touches at least one of the other central leg portions (9). Therefore, the central leg portions (9) do not need to be welded together, in order to reinforce each other.

Unique locking action at the “locking legs”, (1) prohibits siphon hose entry as well as removal of the anti-siphon device from the fuel inlet (6). The finished assembly provides a locking action against flanges (8) within the metal inlet tube (6), and also creates back pressure when a siphoning hose is inserted through the fuel inlet (6). In one mode of installation, the user compresses the lower leg portions (7) by hand, and inserts the device into the inlet (6). The user then releases the pressure on the device, and the locking legs (1) move into contact with the flanges (8) in the fuel inlet tube (6). The locking legs (1) prevent the device from being removed from the inlet (6), and create a physical barrier to siphons. The blocking element also creates a physical barrier to siphons. Furthermore, the device creates back pressure when a siphoning hose is inserted through the fuel inlet (6).

In another mode of installation the user compresses the lower portions (7) of the locking legs (1) by hand, inserts the device into the fuel inlet (6), and uses clockwise turns with a screwdriver, employing about 30 foot-pounds of pressure, on the blocking element, to finish installing the device. The locking legs (1) move into contact with the flanges (8).

The device provides a convenient solution that is both permanent and cost-effective. The use of the device can be shown in the diagrams as follows.

The preferred embodiment is preferable, in part because it uses less material, in total, than the second embodiment. The preferred embodiment also does not require that any of its components be welded together, which makes it easier to build than the second embodiment. If devices of both embodiments are constructed out of the same material, and inserted into a gasoline inlet of the same size, the device of the preferred embodiment will usually resist more pressure, from thieves trying to remove it, than the device of the second embodiment.

In both the preferred and second embodiments, the locking legs (1) are more able to resist pressure because of other components of the device. These components include the locking arm (13) in the preferred embodiment, and the central blocking element portion (5) of the blocking element, which is welded to the central leg portions (9) in the second embodiment.

More Information about the Second Embodiment

The second embodiment of the invention can be inserted into a fuel inlet (6) via four 360 degree turns. It can also be installed into an inlet in the same manner as the preferred embodiment, discussed above. This embodiment also creates back pressure when a siphoning hose is inserted through the fuel inlet (6), and the blocking element of this embodiment also creates a physical barrier to siphons.

This embodiment contains locking legs (1) of the same design as the primary embodiment. The upper loops (14) of the upper blocking element portion (4) of the blocking element form a helix, which should contain at least four upper loops (14), though it will work with fewer. The central blocking element portion (5) of the blocking element is attached to the central leg portion (9) to lock the assembly together. The central blocking element portion (5) can be attached to the central leg portion (9) by welding, or by other methods that have the same effect. When the second embodiment of the device is screwed into a fuel inlet (6) in the above manner, the locking legs (1) of the preferred embodiment will generally withstand at least 100 foot-pounds of pressure against the flanges (8), making the device an effective siphon deterrent that is very difficult to remove from the inlet (8). The locking legs (1) exert pressure on the flanges (8) because of the additional rigidity of the device created by the fact that the central blocking element portion (5) is welded to the central leg portions (9). This makes the device harder to remove. Thieves who try to put a siphon into an inlet (6) containing the device will also find that the device prevents the siphon from drawing any fuel out of the inlet (6). This embodiment of the device can also contain a hose spear (19), which will also jut upwards from the aggregated central leg portions (9), and will puncture siphons in the same manner as the hose spear (19) of the preferred embodiment. The blocking element and locking legs of this second embodiment can be compressed in the same manner as the blocking element and locking legs of the preferred embodiment to allow the locking legs (1) to be inserted into the flanges (8) of a fuel tank. Devices embodying the design of either the preferred embodiment or the second embodiment can also be designed to fit into an inlet (6) that is 1.5875 cm (⅝ inches) in diameter.

However, versions of both the preferred, and second, embodiments, of different sizes are possible, to fit into inlet tubes (6) of different sizes. The steel, which is the recommended construction material, will perform successfully in versions of the device that have a wide variation of sizes. It is possible to build the preferred embodiment using a uniquely efficient single length construction composed of bright 0.060 inch (0.1524 cm) stainless steel spring wire. This wire can also be used for the second embodiment, including the locking legs (1), blocking element, and the rest of the assembly. The device may also be composed of several wires. Those skilled in the art will realize that it is possible to make numerous modifications to the device without departing from the spirit of the claimed invention.

### Further Embodiments

The inventor recommends that the device be made of spring-tempered steel for the reasons listed above, but any material with similar characteristics to spring-tempered steel will suffice for construction of the invention. Furthermore, any method of holding the central blocking element portion (5) to the central leg portions (9) with similar characteristics to welding should be considered a variation of the present invention, and explicitly contemplated by the present invention.

It is also possible for the device to include more than four locking legs (1). For example, a variation of the device with eight locking legs (1) is possible.

Any device that utilizes the locking legs to “lock” onto the flanges of an inlet of a fuel tank, and that includes a means for impeding movement of the locking legs, which impedes movement of the locking legs in a way that makes them harder to remove from the inlet, once they have locked onto the flanges (8) of the inlet, and which also includes a blocking element that impedes the movement of siphons into the inlet, where the blocking element is connected to the locking legs, should be considered a variation of the present invention.

Devices that use components of the types here, used in the configuration discussed here, to stop theft of other liquids besides fuel, should also be considered part of the claimed invention.

The discussion included in this patent is intended to serve as a basic description. The reader should be aware that the specific discussion may not explicitly describe all embodiments possible, and alternatives are implicit, or obvious to those skilled in the art. Also, this discussion may not fully explain the generic nature of the invention and may not explicitly show how each feature or element can actually represent equivalent elements. Again, these are implicitly included in this disclosure. Where the invention is described in device-oriented terminology, each element of the device implicitly performs a function. It should also be understood that a variety of changes may be made to the embodiments that have been described, without departing from the essence of the invention. Such changes are implicitly included in the description. These changes still fall within the scope of this invention.

Furthermore, each of the various elements of the invention and claims may also be achieved in a variety of manners. This disclosure should be understood to encompass each such variation, whether it is a variation of an apparatus embodiment, a method embodiment, or a variation in any element of an embodiment. As the disclosure relates to elements of the invention, the words describing each element may be replaced by equivalent apparatus terms, even if only the function or result is the same. Such equivalent, broader, or even more generic terms should be considered to be encompassed in the description of each element or action. Such terms can be substituted, when desired, to make explicit the implicitly broad coverage to which this invention is entitled. It should be understood that all actions may be expressed as a means for taking the action in question, or may be expressed as an element for causing the action in question. Similarly, each physical element disclosed should be understood to encompass a disclosure of the action which that physical element facilitates. Such changes and terms are to be understood to be explicitly included in the description.

### The Processes

The invention also includes a process of preventing theft of liquid by using a device similar to the device disclosed in this application. The process includes placing a device of the preferred or second embodiment, or another embodiment of the device of the invention, in an inlet tube leading to a tank or reservoir of the liquid, and then installing the device in the tube, in the manner described above.

In addition, the invention includes a process of installing the device of the preferred or second embodiment in the inlet tube of a vehicle, by hand-compressing the lower leg portions (7) of the locking legs (1), inserting the device into the inlet tube (6), and then using a screwdriver to turn the device 360 degrees four times.

### BRIEF DESCRIPTION OF THE DRAWINGS

FIG. 1 shows the preferred embodiment of the device, in use inside the inlet of a gasoline tank.

FIG. 2 shows the preferred embodiment of the device lengthwise.

FIG. 3 shows the preferred embodiment of the device from above.

FIG. 4 shows the preferred embodiment of the device from below.

FIG. 5 shows a “close-up” magnified view of the center of the preferred embodiment of the device.

FIG. 6 shows a “bird's-eye” view of the preferred embodiment of the center of the device.

FIG. 7 shows a view of the preferred embodiment of the device from another perspective.

FIG. 8 shows the second embodiment of the device lengthwise.

FIG. 9 also shows the second embodiment of the device lengthwise, but from a different angle, so that the central blocking element portion (5) can be seen.

FIG. 10 shows the second embodiment of the device from above.

### DETAILED DESCRIPTION OF THE DRAWINGS

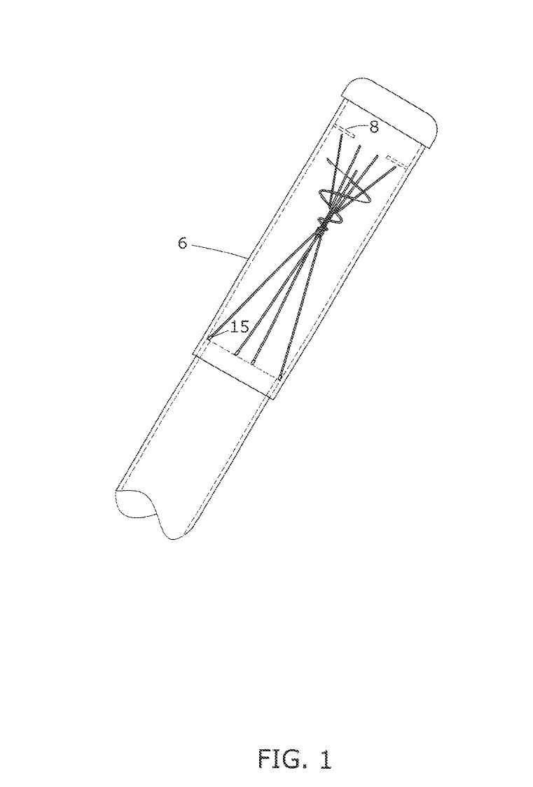

FIG. 1 shows the preferred embodiment of the device, in use inside the inlet of a gasoline tank. The device's locking legs lock against the flanges (8) of the gasoline inlet (6), making the device very hard to remove. The device does not prevent normal gasoline hoses from being inserted into the tank, to put gasoline in the tank. However, the hose spear, which is visible in this drawing but not numbered, will puncture siphons that poke far into the tank to steal gasoline. The helix guards (15) are at the lower tips of the locking legs and are pushed against the flanges of the inlet (6).

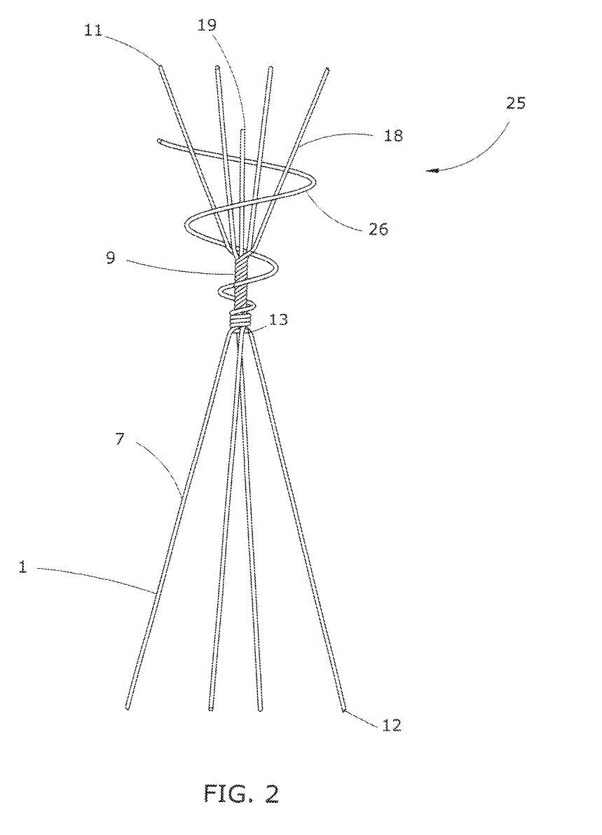

FIG. 2 shows the preferred embodiment of the device lengthwise. Here, the four locking legs (1) of the device can be seen. Each of the locking legs has an upper leg portion (18), a lower leg portion (7), and a central leg portion (9). One of each of these is labeled. The lower leg portions (7) each terminate in a lower tip (12). The locking arm (13) can be seen beneath the central leg portion (9). It exerts pressure against the lower leg portions (7) of the locking legs (1), and prevents them from being pushed inward easily, or made more parallel to each other easily. This facilitates the device's functioning, as shown and discussed in FIG. 1. The locking arm (13) is a part of the blocking element. The top portion (25) of the blocking element is the other part of the blocking element. The top portion (25) is indicated, and one of the covering loops (26) which the top portion (25) comprises is also indicated. The hose spear (19) is shown protruding up from the central leg portion (9) of the locking legs (1), where the locking legs (1) are twisted into a spiral shape. The upper tips (11) of the locking legs are visible at the top of the locking legs (1).

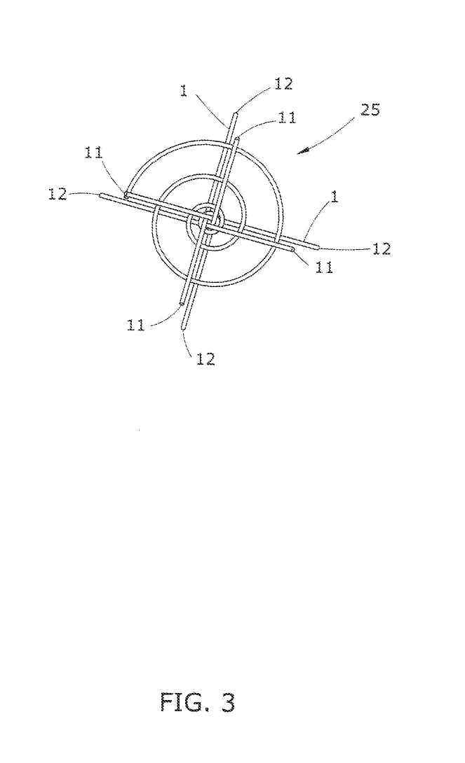

FIG. 3 shows the preferred embodiment of the device from above. Here, the top portion (25) of the blocking element is indicated, and the locking legs (1) can also be seen. The top portion (25) surrounds parts the locking legs (1). The locking legs (1) begin at the upper tips (11), converge towards their central leg portions, and then diverge from the central leg portions towards their lower tips (12).

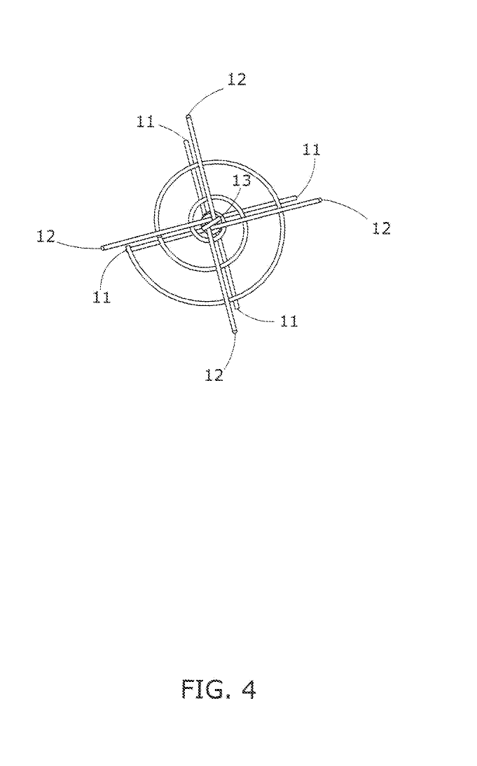

FIG. 4 shows the preferred embodiment of the device from below. Here, the top portion (25) and the manner in which it surrounds parts of the locking legs (1) can also be seen. The locking legs (1) converge towards their central leg portions, and the locking arm (13) is at the bottom of these central leg portions. The manner in which the locking legs (1) diverge towards their lower tips (12) below their central leg portions can be seen better in this figure. The way in which the locking arm (13) exerts pressure on the central leg portions and prevents them from easily becoming more parallel can also be seen.

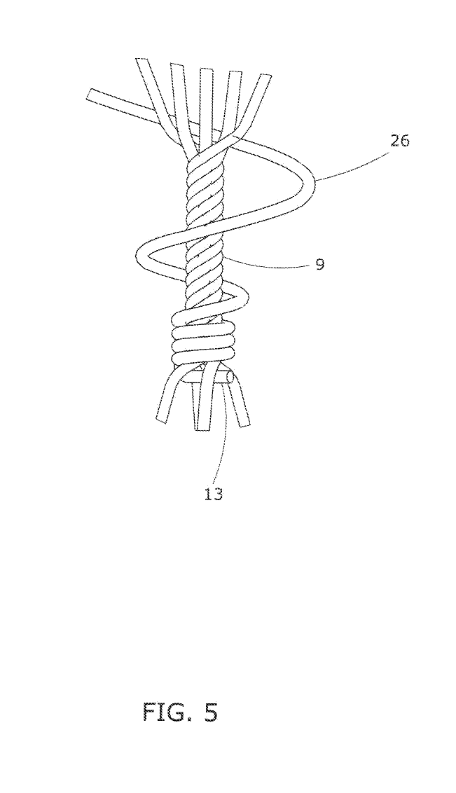

FIG. 5 shows a “close-up” magnified view of the center of the preferred embodiment of the device. Here one of the covering loops (26) is indicated. The central leg portions (9) and the way in which some of the covering loops (26) surround the central leg portions (9) can also be seen. The locking arm (13) is also visible below the central leg portions (9) and is connected to the covering loops (26). The manner in which it touches, and exerts pressure on, the lower leg portions can be seen.

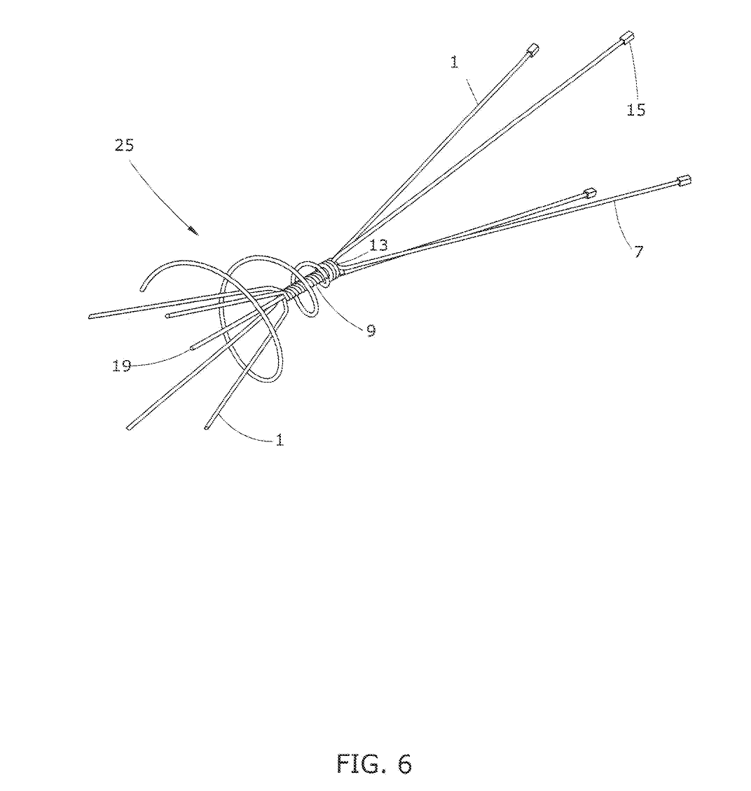

FIG. 6 shows a “bird's-eye” view of the preferred embodiment of the center of the device. This embodiment of the device has helix guards (15) on its lower tips. The upper leg portions (18) of the locking legs (1) move closer together, and converge, in the central leg portions (9) which are twisted together. The hose spear (19) protrudes from the central leg portions, and can poke holes in siphons used to steal gasoline. The blocking element is also visible, and the top portion (25) is a helix further comprised of covering loops that gradually grow smaller in diameter until they reach the central leg portions (9). The blocking element then terminates in the locking arm (13). The lower leg portions (7) of the locking legs (1) continue below the locking arm (13), and they terminate in the lower tips, which are covered in this figure by the helix guards (15).

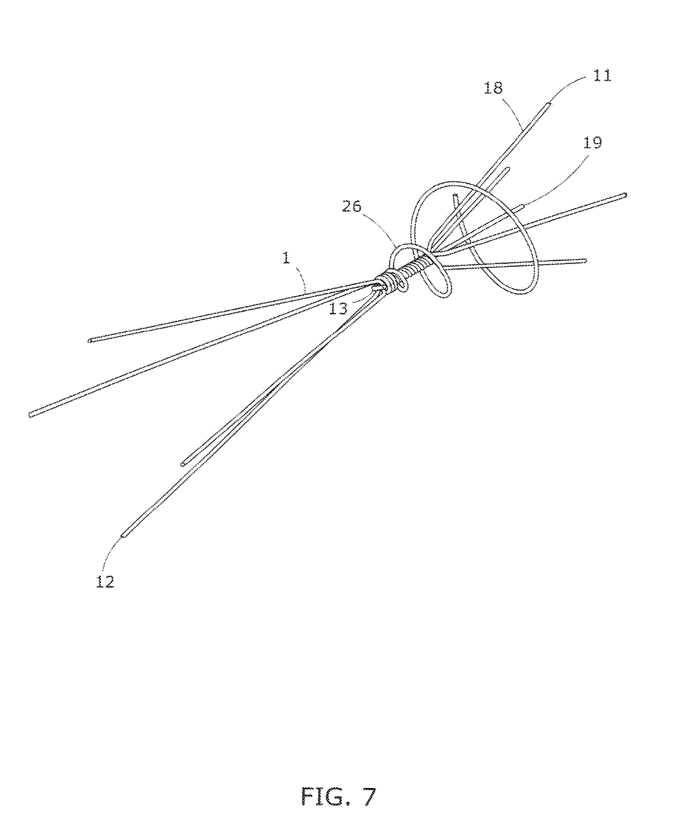

FIG. 7 shows a view of the preferred embodiment of the device from another perspective. The locking legs (1) can be seen, beginning in the upper tips (11). The upper leg portions (18) proceed, and gradually converge, towards the central leg portions. The locking arm (13) can be seen at the bottom of the central leg portions. The top portion spirals around and surrounds parts of the upper leg portions (18) and central leg portions. The top portion is comprised of covering loops (26), one of which is indicated. The lower leg portions diverge gradually, and terminate in the lower tips (12). The hose spear (19) is also visible.

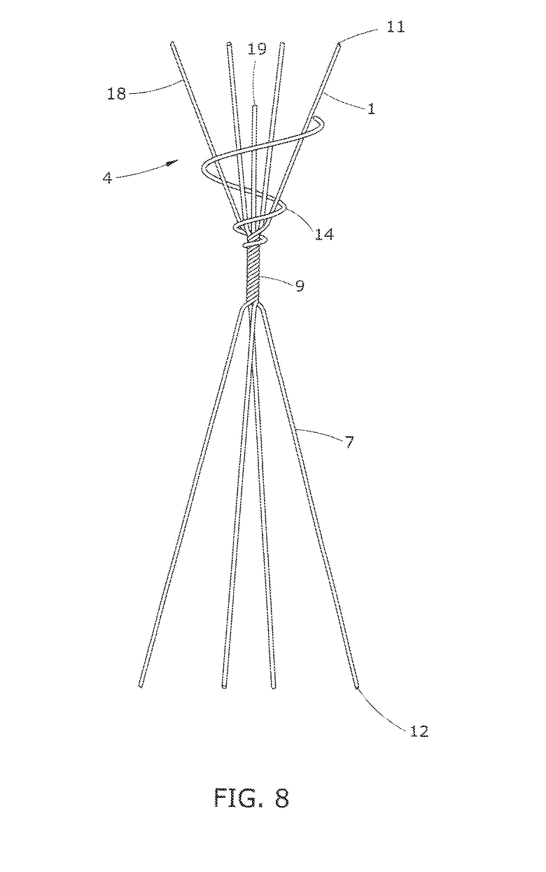

FIG. 8 shows the second embodiment of the device lengthwise. This embodiment includes the central blocking element portion, which is not shown. It is behind the central leg portions (9) in this figure. The locking legs (1) begin here with the upper tips (11), from which the upper leg portions (18) proceed. The upper leg portions (18) converge gradually until they reach the central leg portions (9), which are spirals, that touch each other, and are twisted together. It is not necessary for them to be welded together. The lower leg portions (18) of the locking legs then diverge until they terminate in the lower tips (12). Here, the blocking element is divided into the upper blocking element portion (4) and the central blocking element portion, which is a long vertical bar, and is not shown in this view. The upper blocking element portion (4) is further divided into upper loops (14). The diameter of the upper loops (14) gradually decreases as they approach the central leg portions (9). The upper blocking element portion (4) and the upper loops (14) terminate when they reach the central blocking element portion (5), which is not shown here. The hose spear (19) can also be seen.

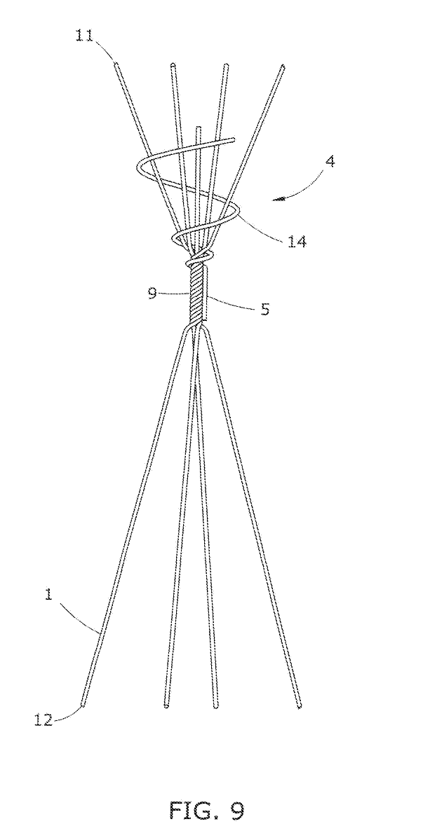

FIG. 9 also shows the second embodiment of the device lengthwise, but from a different angle, so that the central blocking element portion (5) can be seen. Here the central blocking element portion (5) can be seen attached to the central leg portions (9). It is recommended that, in this embodiment, the central blocking element portion (5) be welded to the central leg portions (9) for better performance. The upper blocking element portion (4) which is comprised of upper loops (14) approaches, and finally terminates in, the central blocking element portion (5). The upper blocking element portion (4) therefore lends strength to the central blocking element portion (5), so that the central blocking element portion (5) can exert more pressure, when necessary, on the central leg portions (9). This makes the device more able to resist removal from a gasoline inlet, once inserted. If a thief tries to remove the device after the gas is inserted into the gas tank, the thief will have to temporarily push the lower leg portions (18) of the locking legs (1) into a more parallel position, which would also push the lower tips (12) closer together. The configuration shown in this drawing causes the upper blocking element portion (4) and the central blocking element portion (5) to exert more pressure on the central leg portions (9), which then exert more pressure on the lower leg portions (18), causing them to resist removal from the gasoline inlet more than they otherwise would.

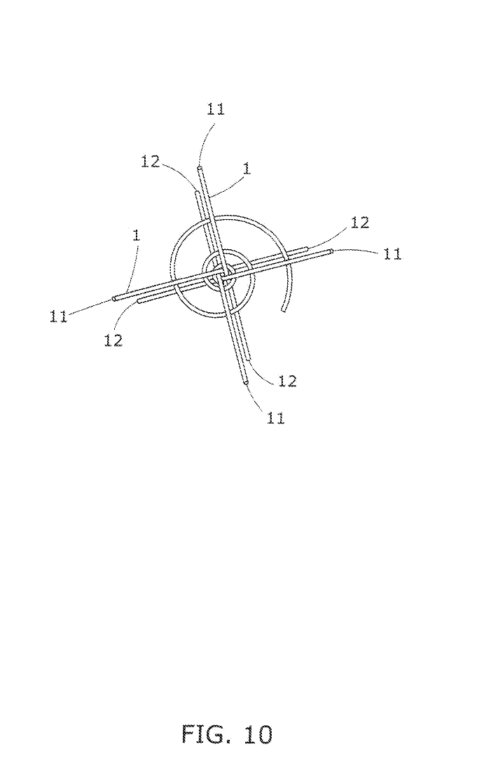

FIG. 10 shows the second embodiment of the device from above. The locking legs (1) can be seen starting at the upper tips (11) converging towards the central leg portions, and below the central leg portions the divergence of the locking legs (1) away from the central leg portions can be seen. Below the central leg portions, the locking legs approach and terminate at the lower tips (12).

1. A device for preventing theft of liquids comprising;
a blocking element, which is capable of being compressed by hand to allow the device to be inserted into an inlet, and, when no longer compressed by hand, is capable of serving as a physical barrier to a siphon when the siphon enters an inlet in which said blocking element has been installed;
a plurality of at least four “locking legs” (1) each comprising an upper leg portion (18) and a lower leg portion (7) and a central leg portion (9), and an upper tip (11) and a lower tip (12);
where each said upper tip (11) is at the top of an upper leg portion (9) and each said lower tip (12) is at the lower end of a lower leg portion (7);
a means for impeding movement of the locking legs (1); where said means for impeding movement of the locking legs (1) provides resistance to the lower leg portions (7) of at least two said locking legs (1) moving in a manner which causes the distance between said lower tips (12) to decrease;
where the user can exert pressure on said lower leg portions (7) in a manner causing the distance between the lower tips (12) to decrease;
where the range of movement of said locking legs (1) allows the distance between said lower tips (12) to decrease, allowing the device to enter an entry hole with diameter smaller than that which the device might be able to enter otherwise;
where the range of movement of said locking legs (1) allows for said locking legs (1) to move to allow said lower tips (12) and upper tips (11) to touch the walls of an inlet (6)when the device is inserted into the inlet (6);
where there is either a direct or indirect connection between said blocking element and said locking legs (1);
where the means for impeding movement of the locking legs makes compression of the locking legs so that said lower tips (12) move closer together more difficult, and therefore makes removal of said device, said blocking element, and said locking legs from an inlet (6) more difficult;
where said “locking legs” (1) have length greater than their breadth or width.

2. A device for preventing theft of liquids comprising;
a blocking element comprising a top portion (25) and a locking arm (13); where said top portion (25) further comprises covering loops (26);
where said top portion (25) is shaped like a helix;
a plurality of at least four “locking legs” (1) each comprising an upper leg portion (18) and a lower leg portion (7) and a central leg portion (9); and further comprising an upper tip (11) and a lower tip (12);
where said upper tips (11) are at the upper ends of said upper leg portions (18) and said lower tips (12) are at the lower ends of said lower leg portions (7);
where said covering loops (26) surround the upper leg portions (18) and central leg portions (9) of all said locking legs (1);
where the diameter of each successive covering loop (26) gradually decreases in the part of said top portion (25) that is above said central leg portion (9) as said top portion (25) approaches said central leg portion (9);
and said locking arm (13) of said blocking element (2) touches said lower leg portions (7) of at least two said locking legs (1) and said locking arm (13) limits the possible directions of movement of these two lower leg portions (7); in a manner which resists their movement in directions which decrease the distance between said lower tips (12);
and said lower tips (12) may be brought closer together when sufficient pressure is exerted on any part of said lower leg portion (7) when the device is outside of an inlet (8), and when said upper leg portion (18), lower leg portion (7) and central leg portion (9) remain connected;
where the range of movement of said locking legs (1) allows for said locking legs (1) to move laterally so that said lower tips (12) can touch the flanges (8) of an inlet (6) when the device is inserted into an inlet (6);
where said locking arm (13) exerts force against said lower leg portion (7) and “locks” said locking legs (1) into position to prevent movement of said lower leg portions (7) in a way that brings said lower tips (12) closer together once the device is inserted into a fuel inlet (6);
and said lower tips (12) or upper tips (11) are engaged with the flanges (8) of the inlet (6);
where said “locking legs” (1) have length greater than their breadth or width.

3. The device of claim 2, further comprising that the diameter of each successive covering loop (26) gradually decreases with a 45 degree camber in the part of said top portion (25) that is above said central leg portion (9) as said top portion (25) approaches said central leg portion (9).

4. The device of claim 2, further comprising that the smaller end of the covering loops' (26) bend should have a 90 degree camber relative to the upper leg portions (18) of the locking legs (1).

5. The device of claim 4, further comprising that said central leg portions (9) of said locking legs (1) are each wound into a spiral shape, and said central leg portions (9) are twisted together so that each of said central leg portions (9) touches at least one other of said central leg portions (9).

6. The device of claim 5 further comprising “helix guards” (15) covering the upper tips (11) of said upper leg portion (18) and/or lower tips (12) of said lower leg portion (7).

7. The device of claim 5 where said blocking element is a spring-tempered stainless steel wire of diameter of 0.060 in. (0.015 cm) or greater.

8. The device of claim 5 where said “locking legs” (1) are made from spring-tempered stainless steel.

9. The device of claim 5 where said “locking legs” (1) are of the correct length, width and breadth to fit into the internal flanges (8) of the gasoline inlet (6) of an automobile, or a light truck, van, pickup truck, or other truck with a similar gasoline inlet (6) to that of an automobile.

10. The device of claim 5 where said “locking legs” (1) are of the correct width and breadth to fit into the internal flanges (8) of the gasoline inlet (6) of a boat.

11. The device of claim 5, further comprising a “hose spear” (19), which is sharp enough to puncture siphons or siphon hose tentacles, that thieves might poke into the fuel inlet (6) into which the device is inserted, thus causing pressure equalization to mitigate siphoning;
where said hose spear (19) juts upwards from said central leg portions (9) towards said upper tips

12. The device of claim 5, further comprising that said locking legs (1) and said blocking element are of sufficient size that said lower leg portions (7) can be moved so that the distance between said lower tips (12) increases sufficiently that, said lower tips (12) press against the flanges (8) of an inlet (6), where said inlet is at least 3.42 cm. (1.25 in.) in diameter.

13. The device of claim 5, further comprising that said locking legs (1) and said blocking element are of sufficient size that said lower leg portions (7) can be moved so that the distance between said lower tips (12) increases sufficiently that, said lower tips (12) press against the flanges (8) of an inlet (6), where said inlet is at least 1.27 cm in diameter.

14. A method of using the device of claim 5 to stop theft of liquid, by inserting said device into an inlet (6), and releasing said device, so that the upper tips (11) and lower tips (12) of the device lock onto the flanges (8) of the inlet, thus preventing thieves from using siphons to steal liquid from the inlet (6) in the future.

15. A method of installing the device of claim 5 in an inlet of a gasoline tank of an automobile or small truck by using the user's hand to compress the lower leg portions (7) of the locking legs (1) of the device, inserting the device into the inlet (6), releasing the compression, and then using a screwdriver to cause the blocking element of the device to make four 360 degree turns, thus permanently installing the device into the inlet.

15. The device of claim 5, further comprising that the lower tips (12) have sharp points.

16. The device of claim 5, further comprising that the hose spear (19) has a sharp point.

17. A device for preventing theft of liquids comprising;
a blocking element, further comprising an upper blocking portion (4) and a central blocking element portion (5);
a plurality of at least four “locking legs” (1) each comprising an upper leg portion (18) and a lower leg portion (7) and a central leg portion (9), and an upper tip (11) at the upper end of said upper leg portion (18) and a lower tip (12) at the lower end of said lower leg portion (7);
a “collar” comprising an area where the central blocking element portion(5) of the blocking element is affixed to said central leg portion (9) of the locking legs (1), holding said central blocking element portion (5) and the central leg portion (9) together;
where said upper blocking element portion (4) is shaped in a helix with positive camber, and twisted into upper loops (14) where the diameter of each successive upper loop (14) gradually decreases as said upper blocking element portion (4) approaches said central blocking element portion (5),
and where said upper loops (14) surround said upper leg portion (18)
and where said central blocking element portion (5) of said blocking element touches and is affixed to said central leg portion (9) in the collar;
and said central leg portion (9) is affixed to said central blocking element portion (5) in a manner which allows said locking legs(1) to move laterally in response to pressure when said locking legs (1) are outside an inlet (8);
where the range of movement of said locking legs (1) allows for said locking legs (1) to move laterally so that said lower tips (12) can touch the flanges (8) of an inlet (6) when the device is inserted into an inlet (6);
where the range of movement of said locking legs (1) allows the distance between said lower tips (12) to decrease, allowing the device to enter an entry hole with diameter smaller than that which the device might be able to enter otherwise;
and said lower tips (12) may be brought closer together when the device is outside of an inlet (8) and pressure is exerted on said locking legs (1), and said upper leg portion (18), lower leg portion (7) and central leg portion (9) remain connected to each other, and said central leg portion (9) remains affixed to said central blocking element portion (5);
and where the manner in which said central leg portion (9) is affixed to said central blocking element portion (5) causes said locking legs (1) to resist removal of the device from an inlet (6), when the device is placed inside an inlet (6) and said locking legs (1) have locked against the flanges (8) of said inlet (6),
where said “locking legs” (1) have length greater than their breadth or width.

18. The device of claim 17, further comprising that said central blocking element portion (5) is affixed to said central leg portions (9) by welding.

19. The device of claim 17, further comprising that said central blocking element portion (5) is a vertical bar.
